(19) United States
(12) Patent Application Publication
(10) Pub. No.: US 2020/0114999 A1
(43) Pub. Date: Apr. 16, 2020

(54) TEMPERATURE SENSING AND CONTROL SYSTEM AND METHOD

(71) Applicant: Polaris Industries Inc., Medina, MN (US)

(72) Inventor: Trevor F. Rhodes, Badger, MN (US)

(21) Appl. No.: 16/156,548

(22) Filed: Oct. 10, 2018

(51) Int. Cl. B62J 33/00; G01K 3/00; G01K 13/00; G01K 7/22; G05D 23/19

(52) U.S. Cl. CPC B62J 33/00; G01K 3/005; B62M 27/02; G01K 7/22; G05D 23/1927; G01K 13/00

(57) ABSTRACT

Disclosed is a vehicle with a heater and a control method and mechanism therefore. The heater may be controlled to a selected temperature, such as by an operator. The heating system may be controlled substantially precisely, such as within a selected range of a temperature selected by the user.

### FIELD

The present disclosure relates to temperature control systems, and particularly rider comfort and operation.

### BACKGROUND

This section provides background information related to the present disclosure which is not necessarily prior art.

Vehicles may be used in various applications and conditions. One example of a vehicle is a snowmobile that is generally exposed to harsh and varying environments. Further, the harsh environment may include low temperatures that may be undesirable to a rider.

Various systems may be provided to cool and/or heat various portions of the vehicle and an operator of the vehicle. For example, a heating system may be provided that heats a portion of the vehicle which the operator contacts. Generally, the system may be operated at a selected current and have selected resistive parties of the heating element to generate heat. Selectively controlling the system, however, may not be provided.

### SUMMARY

This section provides a general summary of the disclosure, and is not a comprehensive disclosure of its full scope or all of its features.

Disclosed is a system that allows for control of a heating element. The heating element may have a system that allows for a measurement and determination of a temperature of the heating element or a volume substantially near or within the heating element. Systems to measure the temperature may include a thermometer positioned at a distance relative to the heating element.

Further the system may include a method and measurement system for measuring a voltage or current through the heating element. Based upon a current or voltage relative to the heating element, a determination of a temperature may be made. The determination of the temperature may allow for control of the heating element to a substantially precise selected temperature.

Disclosed is a system that allows for maintaining a selected temperature within a selected range. For example, an operator or system may select a temperature, such as about 30° C., to be maintained. The system may read or measure a temperature of the heating element or an area near the heating element at a selected rate. Based on the measured temperature, the system may alter a current or power provided to the heating element to achieve or maintain a selected temperature.

In various embodiments is disclosed a system to control a temperature of a heater. The system includes an input having (i) an input member for a user select a temperature and (ii) generate a signal based on the input, a heating element configured to generate heat when a current is driven through a conductive member of the heating element, a driver to drive the current to the heating element, and a controller configured to control a temperature of the heating element. The controller is configurable for receiving a temperature signal based on a temperature of the heating element, comparing the received temperature to a selected temperature, and outputting a duty cycle signal to control the current to the heating element based on the compared received temperature to the selected temperature.

In various embodiments, a method to control a temperature of a heater is disclosed. The method includes receiving an input signal from an input member by a user to select a temperature. A duty signal is determined with a controller to drive a current to a heating element according to a duty signal and generating heat with the heating element. The duty signal is determined by a controller at least by receiving a temperature signal based on a temperature of the heating element, comparing the received temperature to the selected temperature, and outputting the duty signal to control the current to the heating element from the driver based on the compared received temperature to the selected temperature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an environmental view of a vehicle, according to various embodiments;

FIG. 2 is a detailed view of a control system, such as a handlebar, according to various embodiments;

FIG. 3 is a block diagram of a heater and related control system, according to various embodiments;

FIG. 4 is a block diagram of a heater and control portions, according to various embodiments; and

FIG. 5 is a flowchart for operation and maintenance of a selected temperature of a heater, according to various embodiments.

Corresponding reference numerals indicate corresponding parts throughout the several views of the drawings.

### DETAILED DESCRIPTION

Example embodiments will now be described more fully with reference to the accompanying drawings. Although the following description includes several examples of a snowmobile application, it is understood that the features herein may be applied to any appropriate vehicle, such as motorcycles, all-terrain vehicles, etc. Moreover, while the description herein includes specific examples of a throttle lever connected to a handlebar, the throttle lever may be connected or actuated with other portions rather than a hand or digits thereof.

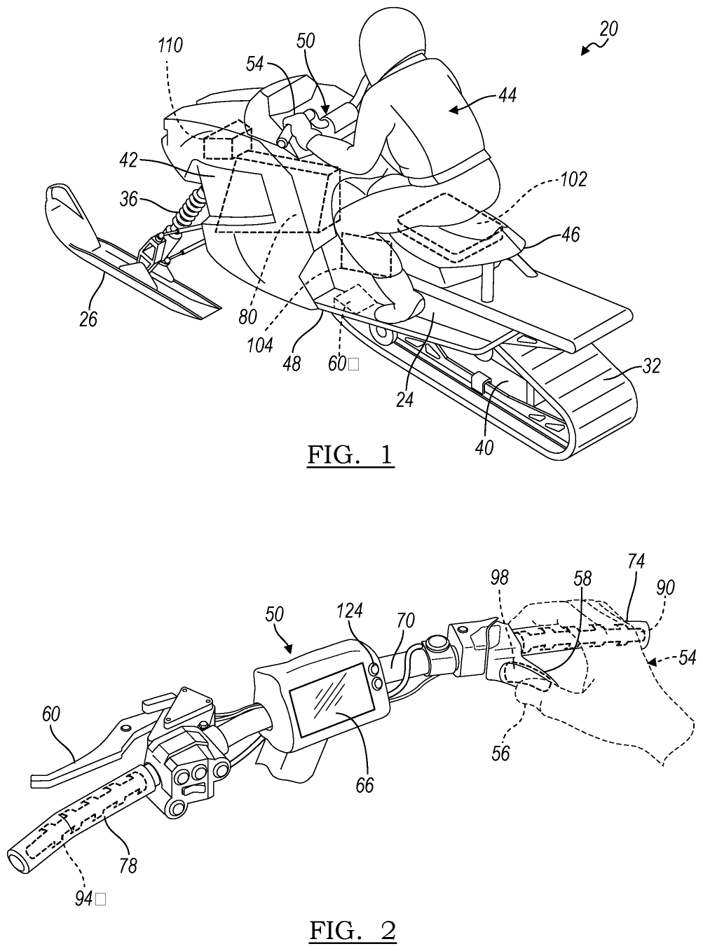

With reference to FIG. 1 and FIG. 2, a snowmobile 20, according to various embodiments, is exemplarily illustrated. Snowmobile 20 may include various assemblies and subassemblies including a frame or frame assembly 24 that is supported by one or more forward or front skis 28 and an endless track assembly 32. Each of the front skis 28 may be supported by a suspension assembly 36 and the endless track assembly 32 may be supported by a rear suspension assembly 40. In addition, the frame assembly 24 may be encapsulated or covered, at least in part, by various body coverings, including a front body covering or cowl 42. The frame 24, track 32, suspension 36, and rear suspension 40 may be appropriate portions such as those included with the RMK® snowmobile, INDY® snowmobile, RUSH® snowmobile, all sold by Polaris Industries, Inc., having a place of business in Minnesota, USA, or any appropriate snowmobile.

An operator, user, or rider 44 may ride or be supported on a seat assembly 46 mounted on the frame assembly 24. The operator 44 may also engage one or more running boards 48 with feet of the operator 44. Further, a steering assembly 50 may be engaged by hands 54 and/or digits 56 of the operator 44, as discussed further herein. The steering assembly 50 may include one or more controls, as discussed herein. The controls may include a throttle flipper or lever 58, a brake lever 60, and an engine stop control 64. Other controls may also include a multiple control panel 66, which may be touch screen panel. All or a selected number of the controls may be mounted to a handlebar 70 of the steering assembly 50. Further, a right grip 74 and a left grip 78 may be provided at the ends of the handle bar 70 for grasping by than hand 54 (or two hands) of the operator 44.

Within the frame assembly 24 and/or cover 42 may be a powertrain including at least an engine 80. The powertrain may be operated by the operator 44 to power the endless track 32, and in turn, move the snowmobile 20 and the operator 44, when riding on the snowmobile 20. The operator 44 may operate the snowmobile 20 by engaging and operating the throttle hand control 58. The throttle hand control 58 may have a linkage to at least a portion of a throttle body in the engine 80, as is understood by one skilled in the art. The linkage may be a direct physical connection, such as a cable, and/or may include an electronic connection, such as with a “drive-by-wire” system. It is further understood, however, that other controls may in addition or alternatively to the above noted controls, such as a foot actuated brake 60′.

With continuing reference to FIG. 1 and FIG. 2, the snowmobile 20 may further include heaters or heating elements that may be incorporated into various portions. The heater may include a conductive member, such as a wire or cord, through which a current is driven. Heat may be produced do to resistance of the conductive member of the heater.

Various heaters may include a right hand heater 90 that may be positioned on or near the right grip 74. A left hand heater 94 may be positioned on or near the left hand grip 78. Further additional heaters may include a thumb or throttle lever heater 98. It is further understood that heaters may be incorporated into various other portions of the snowmobile 20, such as a seat heater 102. Other heating elements may also be positioned near other portions of the rider 44, such as a knee or leg heater 104.

Each of the heaters may be provided in various assemblies of the snowmobile 20, such as incorporated into the seat 46, such as positioned within a portion of the padding just below an outer cover of the seat 46. Further, the left and right hand heaters 94, 90, respectively, may be formed into the respective grips 74, 78 and/or placed under the grips 74, 78 on the handle bar 70. It is understood, therefore, that the heating elements or heater positions that radiate thermal energy may be incorporated into various portions of the snowmobile 20, according to any appropriate embodiment.

The heating elements, such as the left and right hand heaters 94, 90 and the thumb heater 98 may include conductive elements that have a selected or certain resistance. The conductive elements may include wire portions that are wrapped into a base or carrier and positioned on the handlebar 70 over which the respective grips 78, 74 are placed. Further, the conductive elements may be incorporated into the material of the grips, such as with an over mold or co-molding process. Leads or contacts may be positioned in the various portions to allow for connection between the respective heating elements, such as the hand heaters 94, 90 and the thumb heater 98, and a seat heater 102 and the leg heater 104 to various power and control portions, as discussed further herein.

The snowmobile 20, as discussed above, can include the engine 80 and also include various electronic components, such as a drive-by-wire throttle system that is activated by the throttle lever 58, the screen 66 which may display information to the rider 44, and other electronic components, such as the heater elements 90, 94. Various electronic components on the snowmobile 20 may be powered by one or more power sources, including a battery 110. Further, the battery 110 may be regenerated or recharged with the various components such as an alternator, a stator assembly, or the like. Power may be drawn from the battery 110 for various purposes such as powering the heaters 90, 94 and illustrating information on the display 66.

In various embodiments, it is understood as discussed above, that one or more heater elements may be provided at various positions on the snowmobile 20. Discussion herein to a heater, including an exemplary heater such as a handgrip heater including the right hand heater 90, is merely exemplary of appropriate or possible heaters that have heating elements (e.g. conductive members). Accordingly, the following discussion regarding a heater, even though singular, may refer to any or all of the heater elements discussed above.

Further, it is understood that the heater elements may be operated all individually or in selected manners. For example, the grip heaters 90, 94 may be set to a specific temperature while the throttle or thumb heater 98 is set to a different temperature. Similarly, the seat heater 102 may be provided or set to a different temperature than the other heaters. It is also understood that each of the heaters may be powered (i.e. controlled) or set to a selected temperature, as discussed further herein, based upon a general setting selected by the rider. For example, the rider may select a high, medium, or low temperature setting and all of the heaters may be set or powered to achieve a selected temperature based upon a general setting set by the rider 44. Although each of the heaters may have different temperature ranges based upon a single general setting by the rider 44, it is understood that the rider 44 need not select a specific temperature for all of the heater elements individually but may select a general setting and the heater elements are heated to the selected temperature.

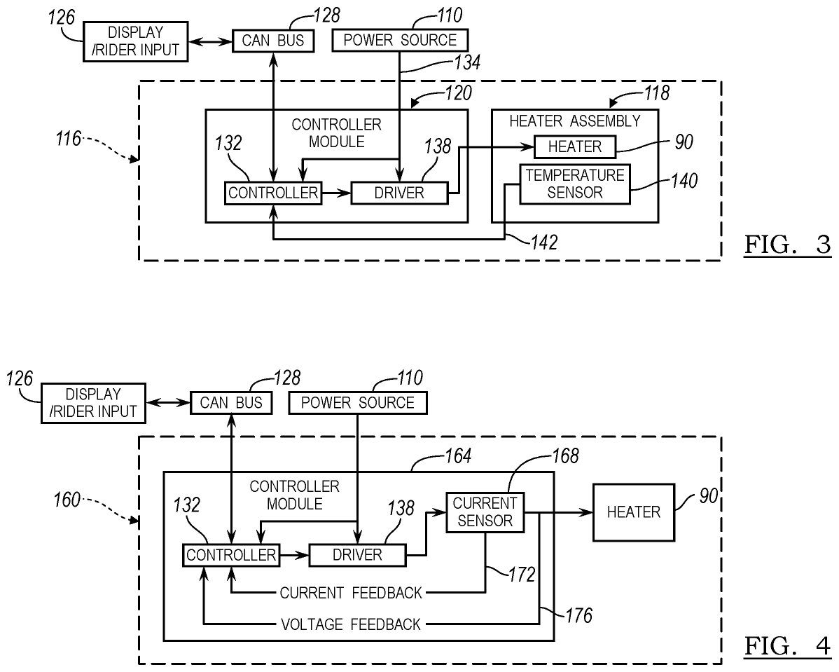

With reference to FIG. 3, a selected heater assembly 118 may include the right hand heater 90 and may be driven and controlled by a control module assembly 120. As discussed above the user or rider 44 may input or select a selected temperature, temperature range, or temperature setting with a selected input system. The input system, as discussed above, may include the screen or display 66 that may display a selected temperature setting. Further, the screen or display 66 may include selected control or input hard buttons or portions associated therewith, such as control hard button 124. Also, or in the alternative, the screen 66 may be a touch screen that allows the rider 44 to input a selection therewith. Accordingly, the display/rider input 126 illustrated in FIG. 3 may include any appropriate portion such as the display 66, the input buttons 124, or other appropriate inputs.

Nevertheless the rider 44 may input a temperature selection that is communicated to the controller module 124 via a selected transmission or communication system such as a CAN Bus 128. The CAN Bus 128 may be an appropriate CAN Bus, such as one understood by one skilled in the art. The CAN Bus 128 may transmit the inputs from the display/rider input 126 to the control module 120, including a controller 132. Further, as discussed herein, the CAN Bus 128 may also transmit information or a signal from the controller module 120 to the display 126. For example, the transmission to the display 126 may include an indication that the selected temperature has been reached, an overload state, a current or an emergency shutoff is occurring, or a measured temperature of the heater 90.

Power may be provided to the control module 120, through a power line 134 form a selected power source, such as the battery 110. As illustrated in FIG. 3 the power source may be the battery 110 from which the controller module is able to draw power. The battery 110, however, is not exclusive of other power sources.

The controller module 120 may include various components, such as the controller 132 and a driver 138. The controller 132 may be any appropriate controller such as a proportional-integral-derivative controller (PID). The driver 138 may be an appropriate driver such as a pulse width modulation (PWM) driver. The PID controller 132 may control the PWM driver 138 to deliver or connect a load, such as a load of the heater 90 of the heater assembly 118, to the power source 110. The driver 138, as discussed herein, drives current to the heater 90 from the power source 110.

As illustrated in FIG. 3, a temperature sensor 140 may be positioned relative to the heater 90 as a part of the heater assembly 118 or positioned near the heater 90. For example, the temperature sensor 140 may be integrated into a coil of wires, positioned below a layer of the heater 90, or otherwise appropriately positioned relative to the heater 90. The temperature sensor 140 may be an appropriate temperature sensor, such as a thermistor.

The temperature sensor 140 may measure the temperature relative to the heater 90 and transmit a temperature signal to the controller 132 based on the sensed temperature. For example, the temperature sensor may transmit a temperature signal that the sensed temperature is 30° C. The controller 132 receives the temperature signal from the temperature sensor 140 and compares the temperature value of the temperature signal to the input selected temperature, such as from the rider input 126. Based upon a comparison of the temperature signal, that may be carried along a single line 142, and the selected or input signal from the rider input 126, the controller 132 controls the driver 138 to allow an appropriate current to the heater 90. As discussed herein, the controller generates a duty signal to the driver 138.

In various embodiments, therefore, the driver 138 may provide a selected or drive a selected current to the load of the heater 90 to achieve the selected temperature. For example, a maximum current may be provided to the heater 90 that may, overtime, allow the heater 90 to reach a temperature greater than the temperature selected by the rider with the rider input 126. However, due to the temperature feedback, such as with the signal from the temperature sensor 140 to the controller 132 controlling the driver 138, the driver 138 may then lower or minimize a current to the heater 90 once a selected temperature is reached and/or as the sensed temperature of the heater 90 gets closer to the selected temperature. Thus, the controller 132 may control the driver 138 to allow for varying currents to the heater 90 based upon a temperature feedback due to the temperature sensor signal to the controller 132 from the temperature sensor 140.

Accordingly, with reference to FIG. 3, the temperature sensor feedback control assembly 116 may include the temperature sensor 140 that senses a temperature near the heater 90 and transmits the temperature signal to the controller 132 that controls the driver 138. Power from the power source 110 may power the controller 132 and the driver 138 to drive the heater 90 based upon the control of the controller 132. The controller module 120, including the controller 132, may transmit to the heater 90 while allowing for control of the heater 90 due to the controller module 120 separate from the CAN bus and/or other control units of the snowmobile 20, including an engine control unit (ECU) or other general controls. Thus, the heater 90 may be controlled separately and independently of any other heater on the snowmobile 20, such as the heater 94. It is understood, therefore, that the temperature sensor heater control assembly 116 may be duplicated, at least including the controller module 120 and the heater assembly 118 for any appropriate heater on the snowmobile 20. As discussed above, however, each of the assemblies may include a connection to the power source 110, communication with the CAN Bus 128, and to the rider input 126.

With reference to FIG. 4, according to various embodiments, the heater 90 may be controlled by determining temperature of the heater 90 with a resistive calculation or measurement control assembly 160, alternatively to or in addition to a temperature sensor. As discussed herein, the resistive temperature control assembly 160 may include a controller module 164 that is also in communication with the CAN Bus 128 and the display/rider input 126. Further, the power source 110 may also be provided and connected to the controller module 164. Accordingly, the display/rider input 126, the CAN Bus 128, and the power source 110 will not be described in great detail here. Further the heater 90, as discussed above, may be any appropriate heater included with the snowmobile 20, including the right hand heater element 90, the left hand heater element 94, the thumb or throttle lever heater 98, or any other appropriate heater. Therefore, also, the heater 90 will also now be described in great detail again. The resistive temperature determination system 160 may be used in addition or alternatively to the temperature sensor 140, thus either system may be the only temperature determination.

The non-temperature sensor control assembly 160 need not include the temperature sensor 140 positioned near the heater 90. According to various embodiments, the controller module 164 may include the controller 132, similar to or identical to the controller 132 discussed above and the driver 138. The driver 138 may also be substantially similar or identical to the driver 138 discussed above. Accordingly, the controller 132 and the driver 138 may control the heater, where the controller 132 controls the driver 138 in a manner similar to that discussed above.

However, as an alternative and/or in addition to the temperature sensor 140, the controller assembly 160 may include a current sensor 168. The current sensor 168 may sense a current from the driver 138 to the heater 90. Further, a current feedback connection signal 172 may be provided between the current sensor 168 and the controller 132. In addition a voltage feedback signal or connection 176 is provided between the controller 132 and the heater 90. Therefore, a calculation may be made to determine a temperature of the heater 90 based upon the sensed or measured voltage 176 and the current 172. As is understood by one skilled in the art a current and voltage may be used to calculate resistance where resistance is R, voltage is V, and current is I and resistance may be calculated by Equation 1:

R=V/I Eq. 1

Based upon the determined resistance from Eq. 1, a temperature T of the conductor of the heater 90 may be determined based on the calculated resistance and various constants of the material of the heater 90 per Equation 2:

T=(R/R_{ref}−1/α+T_{ref}) Eq. 2

Eq. 2 is used to calculate the temperature T of the conductor of the heater 90 at any given instant based on the calculated or determined resistance. In Eq. 2, R is the measured resistance or calculated resistance of the conductor of the heater 90, R_{ref} is a resistance at a reference temperature T_{ref}. The reference temperature may be any appropriate temperature, such as about 20° C., 0° C. or any appropriate reference temperature. A temperature coefficient of resistance is a for the conductor material of the heater 90. As discussed above, the heater 90 may be formed of a selected conductive material that has a resistance that varies based upon temperature. The constant α is the determined temperature coefficient resistance for the material of the conductor in the heater 90. Generally the constant α may be determined through experimental means and/or determined and known based upon the selected material of the conductor of the heater 90.

The controller 132 may include a selected processor, such as a processor that is programed with selected instructions, a processor that is an application specific integrated circuit (ASIC), or any other appropriate processing assembly. The controller 132, in various embodiments, executes instructions that embody an algorithm, to determine or calculate the resistance R per Eq. 1 and the instant temperature based upon the known constants R_{ref}, T_{ref}, and a and based upon the calculated resistance of the heater conductor 90 per Eq. 2. The resistance, as discussed above, is calculated based upon the current feedback 172 and the voltage feedback 176. Thus, the controller 132 may generate a signal to the driver 138 to drive or allow a current to the heater 90 to achieve a selected temperature, as discussed above.

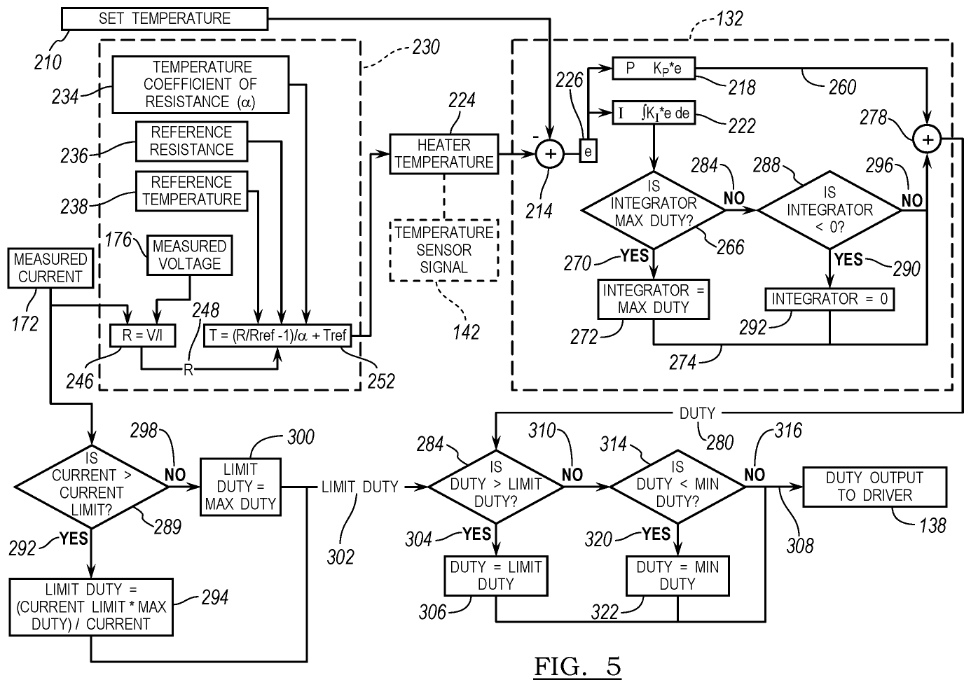

Various control schemes may be used to operate the heater 90, such as with the temperature sensor 140, or without the temperature sensor assembly 160. In various embodiments, controlling the temperature of the heater 90 to achieve a selected temperature is discussed as illustrated in FIG. 5.

With reference to FIG. 5, a control flowchart or scheme 200 is illustrated. The flowchart 200 may include the various components and segments, as discussed above. Generally, the flowchart 200 may describe or illustrate inputs and processes that are executed by various portions of the controller module 120, 164, as discussed above. Accordingly, the control scheme 200 may be used to control the temperature of the heater 90, according to various embodiments.

Generally, as discussed above, the user 44 may identify or input a selected temperature in block 210. The selected temperature may be in the appropriate selected temperature, such as a discretely selected temperature (e.g. 20° C., 25° C., 30° C., 40° C., etc.). The selected temperature may also or alternatively be, for example, a selected range or general temperature such as high, medium, or low. The controller 132 may include a memory or access a memory in the controller module 120, 164 that has a selected set temperature or range of temperatures for the selected general temperature range selected by the rider 44. Accordingly, any appropriate set temperature may be determined by the rider 44, such as by accessing the hard selection buttons 124 and/or a screen, such as a touchscreen 66. Nevertheless, the set temperature may be input as a set point or additional point into a calculation process, such as summation process 214 of the controller 132.

The controller 132 may include various portions, it may be any appropriate controller such as a PID controller, as discussed above. As discussed further herein, however, only selected portions of the PID controller may be used such as only a proportional term or computational block 218 and an integral computational terminal block 222. Accordingly, various computational portions, such as a derivative term, may not be used in selected embodiments. A heater temperature calculation may be made, in the heater temperature signal 224, and may also be sent to the summation process 214. A difference between the set temperature 210 and the determined heater temperature 224 may generate an error term 226. The error term 226 may be determined in the controller 132 by calculating a difference between the set temperature 210 and the heater temperature 224 and the proportional terms 218 and integral terms 222 may be calculated based upon the error term 226.

The heater temperature 224 may be determined based upon the systems, such as those discussed above. For example, as illustrated in FIG. 3, the temperature sensor 140 generates a temperature sensor signal 142. The temperature sensor signal 142 may be the heater temperature 224. As understood, however, a calculation of the temperature of the heater 90 may be also based upon the calculations as discussed above, such as in Eq. 1 and Eq. 2. A resistive temperature signal 230 may be determined as the heater temperature 224. It is understand that the temperature sensor signal 142 may be used in addition and/or alternatively to the resistive temperature signal 230 as the heater temperature 224. Accordingly, the flow chart 200 may incorporate the heater temperature 224 based upon any appropriate determinations such as measuring with the temperature sensor 140 to generate the temperature sensor signal 142 or based upon a calculation of the resistance of the heater 90 in the calculation block 230.

The resistance temperature calculation 230 may be based upon the values as discussed above. Accordingly, a temperature coefficient of resistance a 234 may be determined and/or recalled from a memory. A reference resistance 236 may also be determined or and/or recalled from a memory. A reference temperature T_{ref} 238 may also be determined or and/or recalled from a memory. As discussed above, a voltage measured in the resistance temperature assembly 160 (FIG. 4) in block 240 (which may be measurement or signal 176 as discussed above) may also be made along with a measured current in block 242 (which may be measurement or signal 172, as discussed above). Each of the measured voltage and measured current may be based upon measuring voltage and current in the heater assembly 160, as illustrated above, it may include various known or selected measurement instruments.

Further, as illustrated in the flowchart 200, the measured voltage in block 240 and a measured current from block 242 may be used to calculate a resistance in block 246 according to the Eq. 1 discussed above. The Eq. 1, discussed above, may be implemented as instruction, such as a generally known algorithm, to be executed by processor portion of the controller 132. It is understood, however, that any appropriate processor may be used to calculate the resistance based upon the measured voltage and current from blocks 240, 242 in block 246.

The calculated resistance is transmitted as a resistance signal 248 to a calculation block 252 to calculate the temperature based upon Eq. 2, as discussed above. Further the calculation of the temperature may receive the temperature coefficient to resistance from block 234, the reference resistance R_{ref} from block 238 and the referenced temperature T_{ref} from block 238. Based upon the calculated resistance in the input from blocks 234, 236, 238 a calculation of a temperature based upon the calculated resistance may be made in block 252. The calculation of the temperature may also be calculated based upon execution of instructions by a selected processor such as one of the controller 132 or any appropriate processor. Regardless of the processor performing the calculation, according to generally known algorithms to calculate the temperature, the calculated temperature may be the heater temperature 224. Thus, the heater temperature 224 may also be based upon a calculation of a temperature based upon a calculation of a resistance of the heater 90.

As illustrated in the flowchart 200, however, the heater temperature 224 and the set temperature 210 are used to determine the error term 226. The error term 226 may then be input to the proportional block 218 and the integral block 222. A proportional term may then be determined based upon a selected K_{P} value times the error term. The selected value K_{P} may be based upon various calculations, tests, or other selected features and input to the controller 132. Therefore, the error term 226 is used to determine the proportional term and a proportional output 260. An integral term may also be determined based upon a selected integral K_{I} value and an integral over time of the error term may be determined. Again, the K_{I} value may be based upon various calculations, tests, or other selected features and input to the controller 132. The integral term may be used to evaluate a future change in the error term, such as the heater 90 increasing the temperature over time and getting closer to the set temperature for block 210. The integral term 222 may output an integral signal 264.

The integral signal 264 is input into a first decision block 266 to determine whether the integral signal 264 is greater than a max duty. The max duty may be a maximum duty for the driver 138 to drive current for the heater 90. If it is determined that the integral signal 264 is greater than the max duty, a YES path 270 is followed to set the integral signal 264 equal to a max duty in block 272. An output signal 274 is sent to a second summation block 278. The proportional signal 260 and the integrator signal 274 may then be summed and provided as an output of a duty output 280 for the driver 138.

If in the determination block 266 it is determined that the integral signal 264 is not greater than the max duty, a NO path 284 is followed to a second determination block 288 to determine if the integral signal 264 is less than zero (0). If it is determined that the integral signal 264 is less than 0, a YES path 290 is followed to block 292 so the integral signal 264 is set equal to 0 and the integral signal output path 274 is followed to the comparison block 278. Further, if the determination block 288 is that the integral signal 264 is greater than 0 is no, a NO path 296 is followed to the summation block 278.

Accordingly, the error term 226, based upon the determined heater temperature 224 and the set temperature 210, may be used in the controller 132 to generate at least a proportional signal and an integral signal to provide a duty output 280. The integral signal may be further analyzed to determine whether it is greater than or equal to a maximum duty and/or less than 0, thus determining that the error term is nearing 0 and that the set temperature is nearly reached, while assuring that a maximum duty of the driver is not exceeded. Accordingly, the control scheme 200 allows for a higher duty cycle or maximum current than a duty or current required to achieve a selected temperature. By allowing a maximum or high duty greater than a duty required to achieve a set temperature, a selected temperature may be reached at a faster rate and the duty may be reduced as the selected or set temperature is neared. Thus, the rider 44 may sense warmth and comfort faster and the selected temperature may be achieved at colder ambient temperatures.

The duty signal 280 enters a decision block 284 that determines whether the duty signal or value is greater than a limit duty. The limit duty is determined based upon the measured current value from block 242 initially entering a determination block 289 to determine whether the measured current is greater than a current limit. The current limit may be based upon a predetermined current limit for the heater 90 and may be any appropriate current limit. The current limit may be recalled by a processor, such as from a memory, or may be incorporated into a memory of the processor. Regardless, the current limit may be determined during an initial assembly or manufacturing of the heater assembly, such as the temperature sensor heater assembly 116 or the heater control assembly 160 without a temperature sensor. For example, the current limit may be based upon selected hardware, such as sensors, connectors, etc. It is understood, however, that the system may further include a memory that allows for writing a selected information, such as a current limit, after manufacturing thereof.

Nevertheless the present or instant measured current from block 242 may be compared to the current limit in block 289. If it is determined that the measured current is greater than a current limit, a YES path 292 to calculate a limit duty that is equal to a current limit multiplied by a max duty divided by the measured current from block 242, as illustrated in block 294. The max duty may be 100% duty cycle for the driver.

If the measured current block 242 is not greater than a current limit a NO path 298 may be followed to a block where the limit duty is set equal to a max duty block 300. The output of the block 300 is the limit duty as is the output of the block 294, depending upon whether or not the YES or NO path 292, 298, respectively, is followed. The limit duty 302 is then used in the determination block 284 to determine whether the duty signal 280 is greater than the limit duty 302, as determined above. The limit duty 302 may be selected based upon certain or selected features or systems, such as hardware systems and sensors. For example, the duty limit may be 100% duty cycle.

If the duty signal 280 is greater than the limit duty, a YES path 304 is followed where a duty signal is set equal to the limit duty in block 306. The signal may then become a duty output signal to the driver 138, as discussed above. It is understood that the driver 138 may include an appropriate selected controller, such as a PWM controller and the duty is the duty cycle for the PWM for driving the heater 90.

If the duty signal 280 is determined to not be greater than the limit duty, a NO path 310 is followed to a further determination block 314 to determine whether the duty signal 280 is less than the minimum duty. The minimum duty may be any appropriate duty signal that may also be predetermined and saved and accessed by the controller, such as the controller 132. The minimum duty may be based upon a selected duty cycle when the rider 44 is determined to activate the heater 90, or any appropriate heater. The minimum duty may be selected based upon certain or selected features or systems, such as hardware systems and sensors. For example, the minimum duty may set to a cycle that or current to allow sensors to determine current and voltage measurements.

Accordingly, as discussed above, the heater 90 may be operated according to the flow system 200 to achieve a selected temperature. Therefore, the duty cycle to the driver 138 may be altered based upon the control scheme 200, however, even when the heater temperature 224 matches the set temperature 210 such that a duty signal 280 may be substantially 0, the heater 90 may still have a minimum duty to assist in maintaining a selected temperature. The minimum duty may be determined and saved to be accessed during operation of the heater assembly.

If the determination block 314 determines that the duty signal 280 is not less than a minimum duty a NO path 316 is followed to transmit to the duty signal 280 to the driver 138, such as a PWM for the driver. If the duty is determined to be less than a minimum duty 314, then a YES path 320 may be followed to set the duty to a minimum duty in block 322 to transmit the duty signal 308 to the driver 138. Accordingly, the duty signal sent to the driver 138 may be the duty signal 280 determined, as discussed above, or may be otherwise set to a limit duty in block 306 or set to a minimum duty in 322 if certain limits and thresholds are met. Accordingly, during the operation of the heater 90 a minimum or maximum duty may not be breached according to the method 200.

Therefore, the rider 44 may operate a heater, such as any of the heaters discussed above or any appropriate heaters included with the vehicle, such as a snowmobile 20, by selecting that the heater should be on or operating. The controller module 120, 164 may then operate according to the flowchart 200 to achieve a selected temperature of the heater, such as the heater 90 based upon an input from the rider 44. As discussed above various assemblies may be implemented to determine the heater temperature (e.g. the temperature sensor 140 or based upon calculating a resistance of a conductor of the heater 90) and the heater temperature may be used to control a duty cycle of the driver 138 to generate heat or thermal energy at the heater 90. Accordingly, the heater 90 may be maintained at a temperature selected by the rider 44 regardless of external environmental conditions, such as temperature, wind speed, or the like. The driver 138 may be operated at a selected to duty that may be altered based upon the measured temperature of the heater 90 to achieve the selected temperature. For a selected and specific temperature (e.g. plus or minus 0.1° C. to about 1° C.) or a range of temperatures or general temperature setting may be determined. Nevertheless, the system may be operated to maintain a temperature within a selected or specified range, such as plus or minus about 0.1° C. to about 1° C.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system to control a temperature of a heater operable to be included in a vehicle, comprising:
a user input to receive an input from a user and generate a signal based on the input;
a heating element configured to generate heat when a voltage is applied across the heating element; and
a controller configured to control a current to the heating element based on a feedback regarding a temperature at a selected location relative to the heating element.

2. The system of claim 1, further comprising:
a handgrip configured to be grasped by a hand or a seat;
wherein the heating element is placed on a portion of the handgrip or the seat.

3. The system of claim 1, further comprising:
a temperature sensor;
wherein the temperature sensor is operable to:
sense the temperature at a location;
transmit a signal indicative of the temperature to the controller.

4. The system of claim 1, wherein the controller is configurable to execute instructions to determine the temperature of the heater element based on a resistance of the heater element and a known temperature coefficient of resistance for a conductor material of the heater element.

5. The system of claim 4, wherein the resistance is determined based on a measured current to the heater element and a measured voltage across the heater element.

6. The system of claim 1, wherein the controller includes a proportional and integral controller that transmits a duty signal to a driver based on the temperature relative to a selected temperature to at least one of achieve or maintain the temperature at the selected temperature.

7. The system of claim 6, wherein the selected temperature is a range of about two degrees.

8. The system of claim 6, wherein the driver is operable to drive the heating element at a first power greater than a second power needed to maintain the selected temperature.

9. The system of claim 6, wherein the duty signal is greater when the temperature is less than the selected temperature.

10. A system to control a temperature of a heater, comprising:
an input having (i) an input member for a user select a temperature and (ii) generate a signal based on the input;
a heating element configured to generate heat when a current is driven through a conductive member of the heating element;
a driver to drive the current to the heating element; and
a controller configured to control a temperature of the heating element at least by:
receiving a temperature signal based on a temperature of the heating element,
comparing the received temperature to a selected temperature, and
outputting a duty cycle signal to control the current to the heating element based on the compared received temperature to the selected temperature.

11. The system of claim 10, further comprising:
a vehicle having at least a ski, a track, a motor to drive the track, and a power source.

12. The system of claim 10, wherein the input member includes a configurable touch screen.

13. The system of claim 10, further comprising:
a temperature sensor operable to sense a temperature near the heating element and transmit the temperature signal.

14. The system of claim 10, wherein the controller is configured to determine a temperature based on a determined resistance of the heating element at least by receiving a signal regarding the current to the heating element and a voltage across the heating element;
wherein the temperature signal is the determined temperature.

15. The system of claim 10, wherein the controller includes a proportional and integral controller that transmits a duty signal to the driver based on the temperature relative to a selected temperature to at least one of achieve or maintain the temperature at the selected temperature.

16. The system of claim 10, wherein the driver is operable to drive the heating element at a first power greater than a second power needed to maintain the selected temperature.

17. A method to control a temperature of a heater, comprising:
receiving an input signal from an input member by a user to select a temperature;
generating heat with a heating element;
driving a current to the heating element according to a duty signal; and
determining the duty signal with a controller at least by:
receiving a temperature signal based on a temperature of the heating element,
comparing the received temperature to the selected temperature, and
outputting the duty signal to control the current to the heating element from the driver based on the compared received temperature to the selected temperature.

18. The method of claim 17, further comprising:
measuring the temperature with a temperature sensor; and
transmitting a temperature signal to be received by the controller.

19. The method of claim 17, further comprising:
measuring the current to the heating element;
measuring a voltage across the heating element;
calculating a resistance based on the measured current and measured voltage; and
determining a temperature of the heating element based on the calculated resistance.

20. The method of claim 17, wherein outputting the duty signal to control the current to the heating element from the driver maintains the temperature of the heating element within a selected range of the user selected temperature.
